(19) United States
(12) Patent Application Publication
(10) Pub. No.: US 2020/0374567 A1
(43) Pub. Date: Nov. 26, 2020

(54) GENERATION APPARATUS, REPRODUCTION APPARATUS, GENERATION METHOD, REPRODUCTION METHOD, CONTROL PROGRAM, AND RECORDING MEDIUM

(71) Applicant: SHARP KABUSHIKI KAISHA, Sakai City, Osaka (JP)

(72) Inventor: YASUAKI TOKUMO, Sakai City, Osaka (JP)

(21) Appl. No.: 16/636,617

(22) PCT Filed: Jul. 31, 2018
(86) PCT No.: PCT/JP2018/028655

§ 371 Date: Feb. 4, 2020

(30) Foreign Application Priority Data
Aug. 7, 2017 (JP) 2017-152321

(51) Int. Cl. H04N 21/2387; H04N 21/472; H04N 21/235

(52) U.S. Cl. CPC H04N 21/2387; H04N 21/2353; H04N 21/472

(57) ABSTRACT

Provided are a generation apparatus and a reproduction apparatus that enable high-speed reproduction of a video to reduce load on a network and a client. In order to solve the above-described problem, a generation apparatus (10) according to one aspect of the present invention includes an information generation unit (111) configured to generate meta-information related to reproduction of a certain partial video in an entire video including partial videos from multiple viewpoints or line-of-sight directions, and a data generation unit (112) configured to generate data indicating a decimation video produced by decimating one or some frames from the certain partial video. A reproduction apparatus (20) according to one aspect of the present invention includes a reproduction processing unit (211) configured to reproduce, with reference to meta-information related to reproduction of a certain partial video in an entire video including partial videos from multiple viewpoints or line-of-sight directions, the certain partial video or a decimation video produced by decimating one or some frames from the certain partial video.

### TECHNICAL FIELD

One aspect of the present invention relates to a generation apparatus and a generation method for generating data related to a video from multiple viewpoints or line-of-sight directions, a reproduction apparatus and a reproduction method for reproducing the data, and a control program and a recording medium related to generation or reproduction of the data.

### BACKGROUND ART

There has been a technique for composing captured videos captured by multiple cameras installed at the same position and thereby generating an omnidirectional video (full spherical video) of 360° in the up, down, left, and right directions or a video of a range equivalent to being omnidirectional. As a similar technique, there is also a technique for composing captured videos of the same imaging object captured by multiple cameras (viewpoints) installed in different positions and thereby generating a multi-viewpoint video.

In recent years, various techniques for distributing a video have been developed. An example of the techniques for distributing a video is Dynamic Adaptive Streaming over HTPP (DASH), for which standardization is currently in progress in Moving Picture Experts Group (MPEG) (NPL 1). In DASH, a format of metadata, such as Media Presentation Description (MPD) data, is specified.

### CITATION LIST

### Non Patent Literature

NPL 1: ISO/IEC 23009-1 Second edition 2014-05-15

### SUMMARY OF INVENTION

### Technical Problem

As a case in which a client-side terminal performs high-speed reproduction of a video that is present on a server and is from a particular viewpoint in a multi-viewpoint video, there has heretofore been a case in which some of the frames are decimated to perform high-speed reproduction. Such high-speed reproduction has the following problems.

Specifically, data corresponding to frames not necessary for the high-speed reproduction of the video is also transmitted from the server side to the client side. This causes extra load on the network between the server and the client.

In addition, the client side needs to perform processing for identifying frames to be decimated (frames not necessary for the reproduction), and this also causes extra load on a CPU in the client.

One aspect of the present invention has been made in view of the above problems, and a main object of the present invention is to provide a generation apparatus and a reproduction apparatus that enable high-speed reproduction of a video to reduce load on a network and a client.

### Solution to Problem

In order to solve the above-described problem, a generation apparatus according to one aspect of the present invention includes an information generation unit configured to generate meta-information related to reproduction of a certain partial video in an entire video including partial videos from multiple viewpoints or line-of-sight directions, and a data generation unit configured to generate data indicating a decimation video produced by decimating one or some frames from the certain partial video. A reproduction apparatus according to one aspect of the present invention includes a reproduction processing unit configured to reproduce, with reference to meta-information related to reproduction of a certain partial video in an entire video including partial videos from multiple viewpoints or line-of-sight directions, the certain partial video or a decimation video produced by decimating one or some frames from the certain partial video.

### Advantageous Effects of Invention

According to one aspect of the present invention, it is possible to provide a generation apparatus and a reproduction apparatus that enable high-speed reproduction of a video to reduce load on a network and a client.

### BRIEF DESCRIPTION OF DRAWINGS

FIG. 1 is a functional block diagram of a generation apparatus and a reproduction apparatus according to Embodiment 1 of the present invention.

FIG. 2 is a diagram illustrating a process for generating MPD data and the like according to Embodiment 1.

FIG. 3 is a diagram for describing part of a process for generating a decimation video by processing a captured video from a viewpoint P according to Embodiment 1.

FIG. 4 is a diagram for describing part of the process for generating the decimation video by processing the captured video from the viewpoint P according to Embodiment 1.

FIG. 5 is a flowchart illustrating an operation of the generation apparatus according to Embodiment 1.

FIG. 6 is a flowchart illustrating an operation of a reproduction apparatus according to Embodiment 1.

FIG. 7 is a diagram for describing part of a process for generating a decimation video by processing a captured video from the viewpoint P according to a modification of Embodiment 1.

FIG. 8 is a diagram for describing part of the process for generating a decimation video by processing the captured video from the viewpoint P according to the modification of Embodiment 1.

FIG. 9 is a diagram illustrating a process for generating MPD data and the like according to Embodiment 2.

FIG. 10 is a diagram for describing part of a process for generating decimation videos by processing captured videos from a viewpoint P and a viewpoint Q according to Embodiment 2.

FIG. 11 is a flowchart illustrating an operation of a generation apparatus according to Embodiment 2.

FIG. 12 is a flowchart illustrating an operation of a reproduction apparatus according to Embodiment 2.

FIG. 13 is a diagram for describing part of a process for generating a decimation video to which three-dimensional model data is added, according to a modification of Embodiment 2.

FIG. 14 is a diagram related to a process for generating a decimation video in another embodiment.

### DESCRIPTION OF EMBODIMENTS

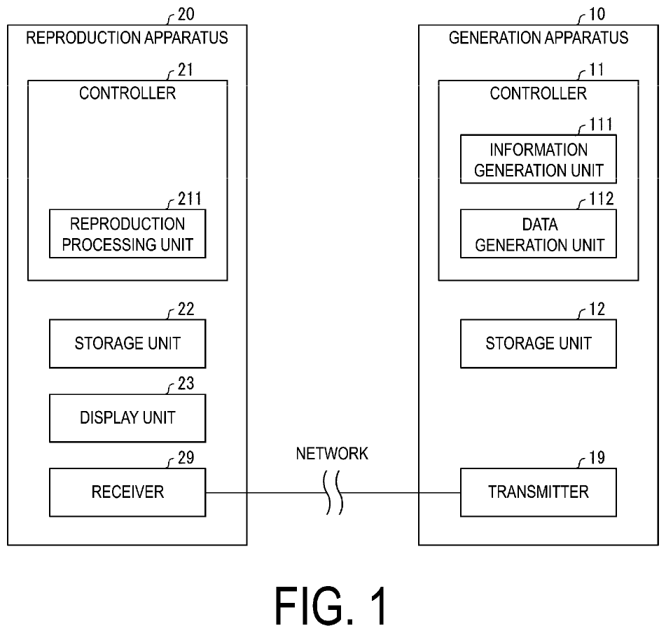

Embodiments of the present invention will be described below with reference to FIGS. 1 to 14.

### Embodiment 1

A multi-viewpoint video system according to an embodiment of the present invention (hereinafter, simply referred to as a “multi-viewpoint video system”) will be described below.

The multi-viewpoint video system performs high-speed reproduction of a certain captured video (certain viewpoint video) in an entire video (multi-viewpoint video) produced by composing captured videos from multiple respective viewpoints circularly surrounding an imaging object. Note that “viewpoint” herein encompasses both the meaning of a location corresponding to a virtual standing position of a user and the meaning of a line-of-sight direction of the user.

In the present embodiment, the generation apparatus is configured to process a captured video and generate a decimation video in which some frames are decimated in advance, and the reproduction apparatus is configured to reproduce the decimation video, in response to receiving an operation for high-speed reproduction of the captured video. Hereinafter, the captured video before processing is also referred to as an original video.

Note that the generation apparatus may be a server including a function (multiple cameras) of generating a multi-viewpoint video itself in addition to a function of generating a decimation video from viewpoint videos (original videos) constituting the multi-viewpoint video. However, the function (multiple cameras) is not essential in the present invention. The generation apparatus (server) not including this function is configured to store in advance an already-captured multi-viewpoint video.

### 1. Configurations of Generation Apparatus 10 and Reproduction Apparatus 20

FIG. 1 is a functional block diagram of a generation apparatus and a reproduction apparatus according to Embodiment 1.

The generation apparatus 10 includes a controller 11, a storage unit 12, and a transmitter 19, and the reproduction apparatus 20 includes a controller 21, a storage unit 22, a display unit 23, and a receiver 29. The controller 11 is a control circuit that controls the entire generation apparatus 10, and functions as an information generation unit 111 and a data generation unit 112. The controller 21 is a control circuit that controls the entire reproduction apparatus 20, and functions as a reproduction processing unit 211.

The storage unit 12 is a storage device that holds data to be referred to or generated in a case of processing a captured video in the generation apparatus 10, and the like. The transmitter 19 is a transmission circuit that transmits data to the reproduction apparatus 20, for example.

The information generation unit 111 generates meta-information related to reproduction of a certain captured video in a multi-viewpoint video.

The data generation unit 112 generates data indicating a decimation video, from an original video.

The storage unit 22 is a storage device that holds data to be referred to at a time of reproducing a video in the reproduction apparatus 20. The display unit 23 is a display panel that displays a video reproduced based on a user operation. The receiver 29 is a reception circuit that receives, for example, data transmitted from the generation apparatus 10.

According to the type of a reproduction operation by a user (standard-speed reproduction or high-speed reproduction), the reproduction processing unit 211 reproduces the original video or the decimation video produced by processing the original video. Note that the generation apparatus and the reproduction apparatus are not necessarily connected via a network as illustrated in FIG. 1, and the generation apparatus 10 and the reproduction apparatus 20 may be directly connected. The storage unit 12 may be external to the generation apparatus 10, and the storage unit 22 and the display unit 23 may be external to the reproduction apparatus 20.

### 2. Regarding MPD Data and Media Segments

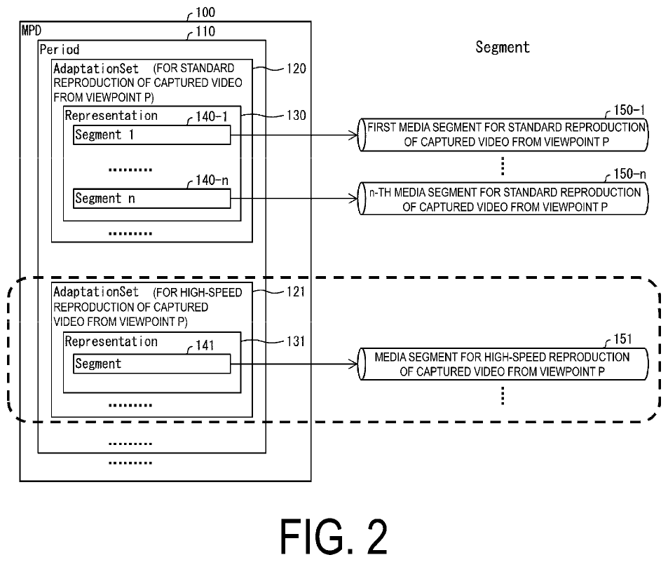

FIG. 2 is a diagram for describing a process for generating MPD data for high-speed reproduction of a captured video from a certain viewpoint P, and a process for reproducing the captured video at high speed with reference to the MPD data. Note that the captured video from the viewpoint P is one of multiple captured videos from multiple different viewpoints, the multiple captured videos being used to compose a multi-viewpoint video.

The MPD data is an example of the aforementioned meta-information related to reproduction of the captured video. A media segments is a transmission unit of HTTP transmission of the original video and the decimation video in a time-division manner (for example, data based on ISO Base Media File Format (ISOBMFF)). Each media segment includes Intra (I) frames, Predictive (P) (unidirectional prediction) frames, and Bi-directional (B) frames.

With reference to this drawing, the MPD data and the media segments will be described in more detail. As illustrated in FIG. 2, the MPD data has a tree structure including an MPD element 100, a Period element 110, AdaptationSet elements (120, 121), Representation elements (130, 131), a SegmentList element, and SegmentURL elements, in the order from a higher-hierarchical element. Note that Segment 1 (140-1), Segment n (140-n), Segment (141), and the like in FIG. 2 correspond to n SegmentURL elements included in the SegmentList element, and the SegmentList element is omitted in FIG. 2.

In the present embodiment, as AdaptationSet elements for reproducing the captured video from the certain viewpoint P, at least two AdaptationSet elements, i.e., an AdaptationSet element 120 for standard-speed reproduction and an AdaptationSet element 121 for high-speed reproduction, are present.

Note that the number of pieces of data of immediately lower hierarchical elements included in each hierarchical element is not necessarily one, and is different depending on the size of video data to be handled and the like. For example, the MPD element may include one Period element as in FIG. 2 or may include multiple Period elements. Each AdaptationSet element typically includes multiple SegmentURL elements by way of the Representation element and the SegmentList element. Specifically, each SegmentURL element (second information) included in the AdaptationSet element 120 for standard-speed reproduction includes information (URL) indicating an obtaining reference of a corresponding one of videos among n media segments into which the original video for a period indicated by the Period element, which is a higher layer, is time-divided.

In the AdaptationSet element 121 for high-speed reproduction, the SegmentURL element 141 (first information) includes information (URL) indicating an obtaining reference of a corresponding one of one or multiple media segments into which a decimation video for the period indicated by the Period element, which is a higher layer, is time-divided.

Index information (for example, index information of a sidx box and a ssix box) included in each media segment will be described below.

Each media segment based on MPEG-DASH includes therein, as meta-information, information called box, such as styp, sidx, ssix, and moof. Among these, the sidx box stores indices identifying the positions of random access points (for example, I frames) included in the corresponding media segment. The L0 layer of the ssix box stores indices identifying the positions of the I frames included in the corresponding media segment, and the L1 layer of the ssix box stores indices identifying the positions of P frames included in the corresponding media segment. In other words, in a case of identifying the positions of the I frames included in each media segment, the sidx box of the media segment itself may be referred to, or the L0 layer of the ssix box of the media segment itself may be referred to.

### 3. Flow of Process in Generation Apparatus 10

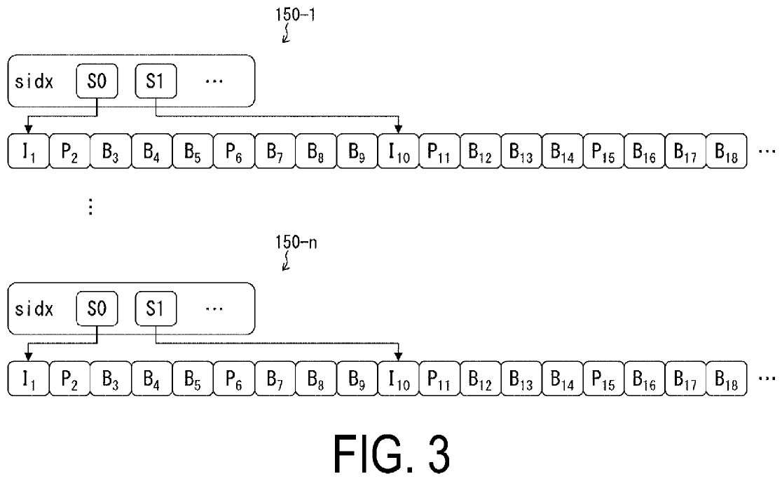

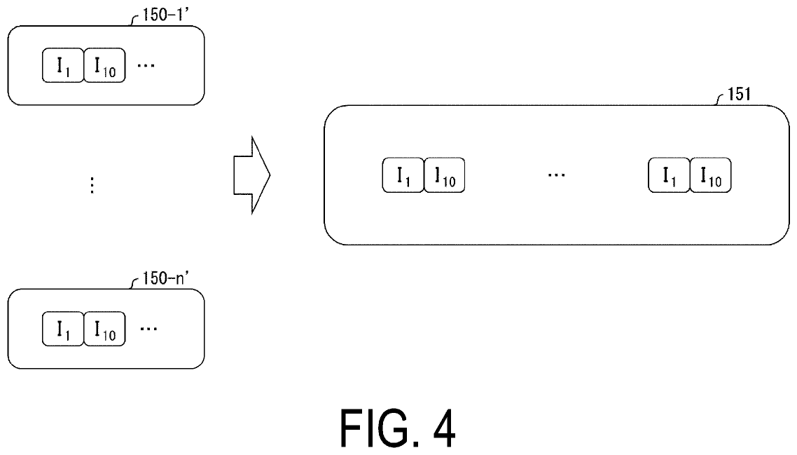

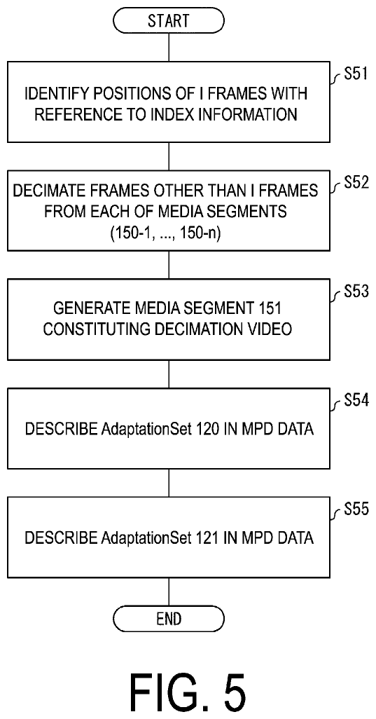

Hereinafter, the operation of the generation apparatus 10 to generate the above-described MPD data and decimation video will be described with reference to FIGS. 2 to 5. FIGS. 3 and 4 are diagrams for describing a process for processing a captured video from the viewpoint P and thereby generating a decimation video. FIG. 5 is a flowchart illustrating the above-described operations of the generation apparatus.

The data generation unit 112 uses the above-described method to identify the positions of I frames for each of the n media segments constituting the original video from the viewpoint P recorded in the storage unit 12 (S51). As illustrated in FIG. 3, the data generation unit 112 decimates frames (B frames and P frames) other than the frames (the I frames, for example, I₁ and I₁₀ in FIG. 3) at the identified positions, from the n media segments (150-1, . . . , 150-n) (S52).

The data generation unit 112 generates a media segment 151 constituting a decimation video, from the n media segments (150-1′, . . . , 151-n′) produced by decimating the B frames and P frames (S53). Specifically, as can be seen in FIGS. 3 and 4, one or multiple media segments that constitute the decimation video are generated such that the I frames at the positions to be presented earlier in the n media segments would be presented earlier.

As a result, the decimation video produced by decimating the B frames and the P frames from the original video is recorded in the storage unit 12, separately from the original video from the viewpoint P.

Thereafter, the generation apparatus 10 performs the following process in addition to a known process for generating MPD data to thereby generate the above-described MPD data.

Specifically, the information generation unit 111 describes, in the MPD data, the AdaptationSet element 120 including n SegmentURL elements (140-1, . . . , 140-n) indicating the obtaining reference of the n media segments (150-1, . . . , 150-n) constituting the original video from the viewpoint P (S54). Further, the information generation unit 111 describes, in the MPD data, the AdaptationSet element 121 including one or more SegmentURL elements 141 indicating the obtaining reference(s) of the one or more media segments 151 constituting the decimation video from the viewpoint P (S55).

As a result, the above-described MPD data 100 for high-speed reproduction (and standard-speed reproduction) of the captured video from the viewpoint P is recorded in the storage unit 12.

### 4. Flow of Process in Reproduction Apparatus 20

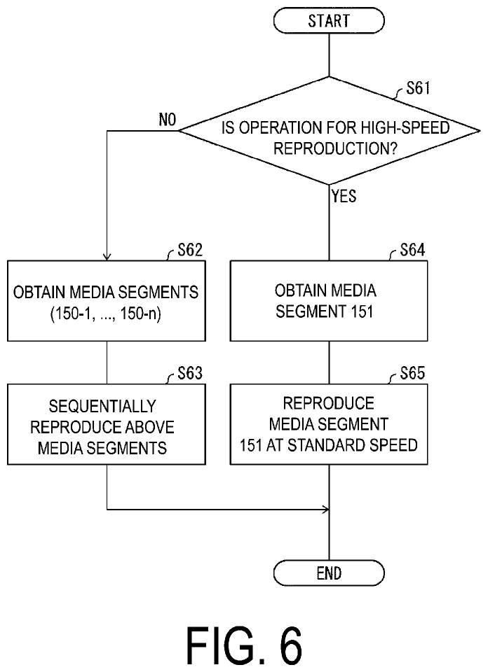

Operations of the reproduction apparatus 20 in a case of receiving an operation for reproducing the captured video from the certain viewpoint P with respect to the above-described MPD data 100 will be described with reference to FIGS. 2 and 6. FIG. 6 is a flowchart illustrating the above-described operations of the reproduction apparatus.

First, the reproduction processing unit 211 determines the type of a received reproduction operation (S61). In a case of determining that an operation for standard reproduction (a second operation) is received, the reproduction processing unit 211 refers to the AdaptationSet element 120 in the MPD data 100 recorded in the storage unit 22.

Specifically, the reproduction processing unit 211 obtains n media segments (150-1, . . . , 150-n) via the receiver 29 with reference to the n SegmentURL elements (140-1, . . . , 140-n) (S62).

The reproduction processing unit 211 reproduces, at standard speed, the obtained n media segments (150-1, . . . , 150-n) in the order of the media segment 150-1, . . . , the media segment 150-n (S63).

In a case of determining that an operation for high-speed reproduction (a first operation) is received, on the other hand, the reproduction processing unit 211 obtains the media segment 151 with reference to the AdaptationSet element 121 (the SegmentURL element 141) in the MPD data 100 recorded in the storage unit 22 (S64).

The reproduction processing unit 211 performs the obtained media segment 151 (the decimation video) at standard speed (S65).

Note that the reproduction apparatus 20 may support low-speed reproduction in addition to standard-speed reproduction and high-speed reproduction. In the reproduction apparatus 20 that supports low-speed reproduction, step S62 may be performed even in a case of receiving an operation for low-speed reproduction, to thereby reproduce the obtained n media segments at low speed.

The reproduction apparatus 20 may perform step S64 in a case of receiving an operation for high-speed reproduction to thereby reproduce the obtained media segment 151 (the decimation video) at high speed (decimation reproduction).

### Modification 1

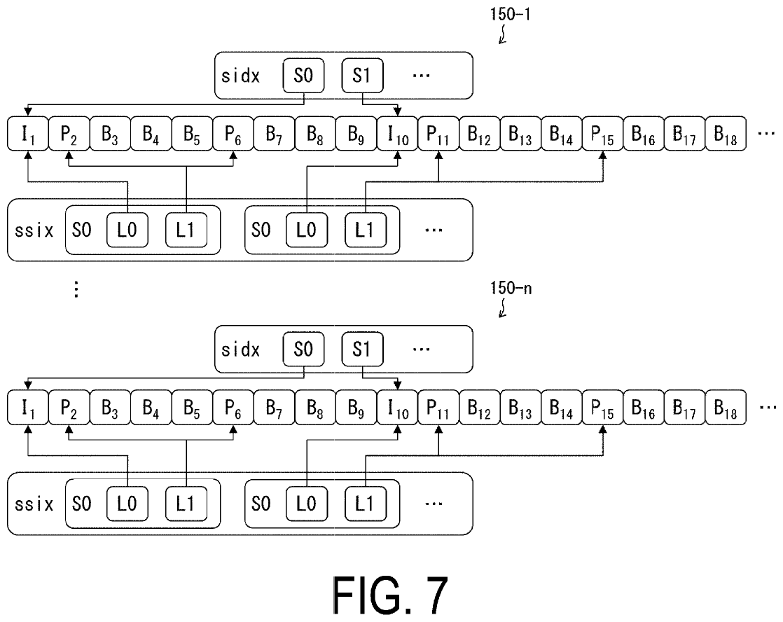

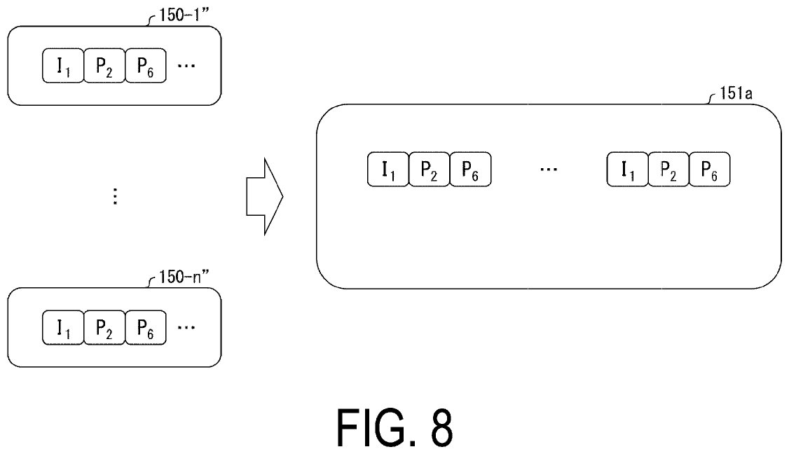

A modification of the present embodiment will be described with reference to FIGS. 7 and 8. FIGS. 7 and 8 are diagrams for describing a modification of the process for processing a captured video from the viewpoint P and thereby generating a decimation video.

In the present modification, as illustrated in FIG. 7, the data generation unit 112 identifies the positions of I frames and P frames with reference to the L0 layer and the L1 layer of the ssix box of media segments (150-1, . . . , 150-n).

The data generation unit 112 decimates frames (B frames) other than the frames (the I frame and the P frame, for example, I₁ and P₂ in FIG. 7) at the identified positions, from each of the n media segments (150-1, . . . , 150-n). As illustrated in FIG. 8, the data generation unit 112 generates a media segment 151a constituting a decimation video, from the n media segments (150-1″, . . . , 150-n″) produced by decimating the B frames.

As a result, the decimation video generated by decimating only the B frames from the original video is recorded in the storage unit 12, separately from the original video from the viewpoint P.

In a case of also using P frames to generate a media segment, the amount of generated data is greater than that in a case of using I frames only, but more smooth high-speed reproduction is achieved compared to the case of using I frames only. In any case, by decimating at least B frames, the reproduction apparatus side does not reproduce the B frames not being able to be reproduced until bi-directional reference images are decoded, at the time of high-speed reproduction of a partial video, so even the reproduction apparatus with low decoding capability exerts the effects of being able to reproduce the partial video at high speed.

### Modification 2

The AdaptationSet element 121 may include a descriptor indicating that the AdaptationSet element 121 is information indicating the obtaining reference of the decimation video.

Examples of such a descriptor include an EssentialProperty element, a SupplementalProperty element, and a mimeType attribute.

### Modification 3

Depending on a user operation, the generation apparatus 10 may have a case of performing a process for generating a decimation video for high-speed reproduction and a process for describing the AdaptationSet element 121 for high-speed reproduction in the MPD data, and a case of not performing these processes.

In the former case, the generation apparatus 10 may describe, in the Profile attribute of the MPD element, an attribute value indicating that the AdaptationSet element 121 for high-speed reproduction is included in the MPD data 100. In the latter case, the generation apparatus 10 may describe, in the Profile attribute of the MPD element, an attribute value indicating that the AdaptationSet element 121 for high-speed reproduction is not included in the MPD data.

In a case of receiving an operation for reproducing a certain viewpoint video (original video) included in a certain multi-viewpoint video at high speed, the reproduction apparatus 20 may switch processes, based on the value of the Profile attribute described in the MPD data corresponding to the multi-viewpoint video.

Specifically, in a case that the attribute value indicates that the AdaptationSet element 121 for high-speed reproduction is included in the MPD data 100, the reproduction apparatus 20 may obtain and reproduce the decimation video generated from the original video, with reference to the AdaptationSet element 121. On the other hand, in a case that the attribute value indicates that the AdaptationSet element 121 for high-speed reproduction is not included in the MPD data 100, the reproduction apparatus 20 may obtain the original video and reproduce the original video at high speed (decimation reproduction) with reference to the AdaptationSet element 120.

Note that Modification 1 to Modification 3 described above are also applicable to embodiments to be described later.

### Advantages of Present Embodiment

As described above, in the generation apparatus 10, the information generation unit 111 generates the MPD data 100 related to reproduction of a certain captured video in a multi-viewpoint video including captured videos from multiple viewpoints.

The data generation unit 112 generates a media segment that indicates a decimation video in which at least B frames are decimated from a certain captured video (original video).

The MPD data 100 includes the AdaptationSet element 121 (the SegmentURL element 141) indicating the obtaining reference of the decimation video to be referred to in response to a high-speed reproduction operation for the certain captured video, and the AdaptationSet element 120 (the SegmentURL elements 140-1, . . . , 140-n) indicating the obtaining reference of the original video to be referred to in response to a standard-speed reproduction operation for the certain captured video.

In the reproduction apparatus 20, the reproduction processing unit 211 reproduces the original video or the decimation video with reference to the MPD data 100.

Specifically, the reproduction processing unit 211 obtains and reproduces the decimation video, based on the AdaptationSet element 121 (the SegmentURL element 141) in response to the high-speed reproduction operation, and obtains and reproduces the original video, based on the AdaptationSet element 120 (the SegmentURL elements 140-1, . . . , 140-n) referred to in response to the standard-speed reproduction operation.

According to the above-described configuration, it is possible to reduce the amount of data transmitted from the generation apparatus 10 side, which is a server, to the reproduction apparatus 20 side, which is a client, in the case of performing high-speed reproduction, by at least the amount of data of B frames, and hence to reduce the load on the network. Furthermore, the reproduction apparatus 20 side need not decimate B frames at the time of high-speed reproduction, so it is possible to perform high-speed reproduction with a small amount of CPU resources.

### Embodiment 2

Another embodiment of the present invention will be described as follows with reference to FIG. 1 and FIGS. 9 to 13. In the present embodiment, a case of reproducing a video from an intermediate viewpoint between a certain viewpoint P and viewpoint Q at high speed in a multi-viewpoint video system will be described.

### 1. Configurations of Generation Apparatus 10 and Reproduction Apparatus 20

The configurations in FIG. 1 are used in the present embodiment similarly to the case of Embodiment 1.

### 2. Regarding MPD Data and Media Segments

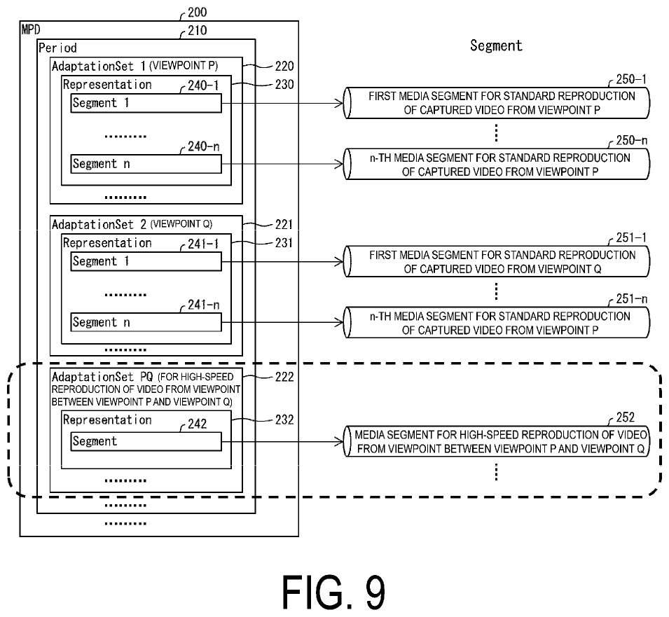

FIG. 9 is a diagram for describing a process for generating MPD data for high-speed reproduction of a video from an intermediate viewpoint between the certain viewpoint P and viewpoint Q, and a process for reproducing a captured video at high speed with reference to MPD data. Note that the viewpoint P and the viewpoint Q (a first viewpoint and a second viewpoint) are viewpoints adjacent to the intermediate viewpoint (a particular viewpoint). Each of captured videos from the viewpoint P and the viewpoint Q is one of multiple captured videos (i.e., original videos) from multiple different viewpoints used to compose a multi-viewpoint video.

Segment 1 (240-1), Segment n (240-n), Segment 1 (241-1), Segment n (241-n), Segment (242), and the like correspond to n SegmentURL elements included in a SegmentList element, and the SegmentList element is omitted in FIG. 9 as in FIG. 2.

In the present embodiment, as AdaptationSet elements for reproducing the captured videos from the certain viewpoint P and viewpoint Q, AdaptationSet 220 and 221 for standard-speed reproduction are present, and an AdaptationSet 222 for high-speed reproduction for reproducing the video from the intermediate viewpoint between the viewpoint P and the viewpoint Q is present.

Note that the number of pieces of data of immediately lower hierarchical elements is not necessarily one, and is different depending on the size of video data to be handled and the like. For example, the MPD element may include one Period element as in FIG. 9 or may include multiple Period elements. Each AdaptationSet element typically includes multiple SegmentURL elements by way of the Representation element and the SegmentList element. Specifically, each SegmentURL element (second information) included in the AdaptationSet elements 220 and 221 for standard-speed reproduction includes information (URL) indicating an obtaining reference of a corresponding one of videos among n media segments into which the original video for a period indicated by the Period element, which is a higher layer, is time-divided.

In the AdaptationSet element 222 for high-speed reproduction, the SegmentURL element 242 (first information) includes information (URL) indicating the obtaining reference of a corresponding one of one or multiple media segments into which decimation videos from the viewpoint P and the viewpoint Q for a period indicated by the Period element, which is a higher layer, are time-divided.

### 3. Flow of Process in Generation Apparatus 10

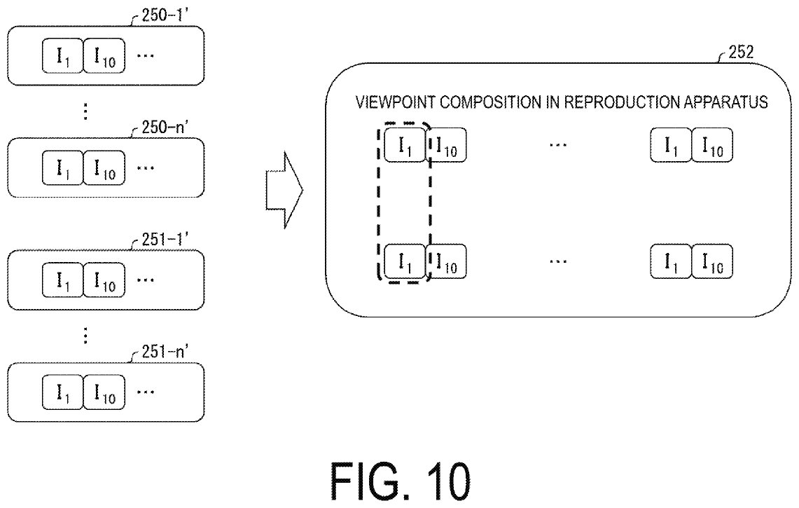

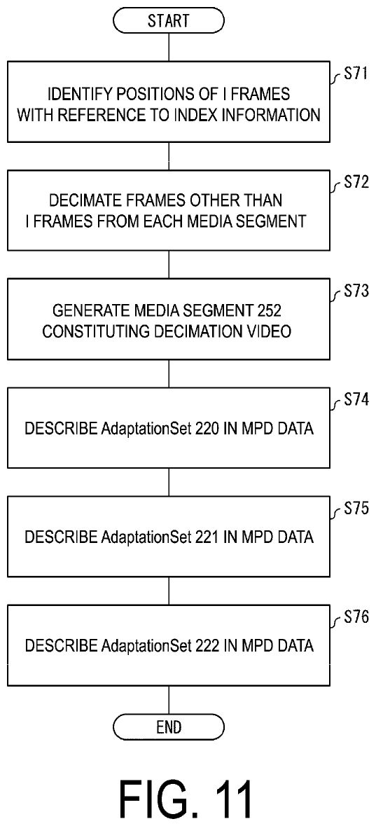

Hereinafter, the operation of the generation apparatus 10 to generate the above-described MPD data and decimation video will be described with reference to FIGS. 9 to 11. FIG. 10 is a diagram for describing a process for generating decimation videos by processing captured videos from the viewpoint P and the viewpoint Q. FIG. 11 is a flowchart illustrating the above-described operations of the generation apparatus.

The data generation unit 112 uses the above-described method to identify the positions of I frames in the above-described method for each of 2n media segments recorded in the storage unit 12 (S71). The 2n media segments are 2n media segments (250-1, . . . , 250-n, 251-1, . . . , 251-n) obtained with reference to the AdaptationSet elements 220 and 221 illustrated in FIG. 9. As illustrated in FIG. 10, the data generation unit 112 decimates frames (B frames and P frames) other than the frames (the I frames, for example, I₁ and I₁₀ in FIG. 10) at the identified positions, from the 2n media segments (250-1, . . . , 250-n, 251-1, . . . , 251-n) (S72). In other words, the data generation unit 112 decimates some frames (B frames and P frames) from the n media segments (250-1, . . . , 250-n) constituting the original video from the viewpoint P. Similarly, the data generation unit 112 decimates some frames (B frames and P frames) that are generated at the same time points as these frames, from each of then media segments (251-1, . . . , 251-n) constituting the original video from the viewpoint Q.

The data generation unit 112 generates a media segment 252 that constitutes a decimation video, from 2n media segments (250-1′, . . . , 250-n′, 251-1′, . . . , 251-n′) produced by decimating the B frames and the P frames.

Specifically, as can be seen in FIG. 10, one or multiple media segments that constitute the decimation video are generated such that the I frames at the positions to be presented earlier in the n media segments would be presented earlier. In the above generation, the I frames (250-1′, . . . , 250-n′) derived from the media segments of the video from the viewpoint P are stored in track 1 of the media segment 252; the I frames (251-1′, . . . , 251-n′) derived from the media segments of the video from the viewpoint Q are stored in track 2 of the media segment 252 (S73).

As a result, the decimation video produced by decimating the B frames and P frames from the original video from the viewpoint P and the decimation video produced by decimating the B frames and P frames from the original video from the viewpoint Q are recorded in different tracks of the media segment 252 in the storage unit 12, separately from the 2n media segments in which the original videos from the viewpoint P and the viewpoint Q are stored. Note that the reproduction apparatus 20 can generate a decimation video from the intermediate viewpoint between the viewpoint P and the viewpoint Q by composing the decimation video from the viewpoint P and the decimation video from the viewpoint Q in a known method and/or a method to be described later in the present specification. Thus, the media segment 252 in which the decimation video from the viewpoint P and the decimation video from the viewpoint Q are stored is, in other words, a media segment in which the decimation video from the intermediate viewpoint between the viewpoint P and the viewpoint Q (a partial video from a particular viewpoint) is stored.

Thereafter, the generation apparatus 10 performs the following process in addition to a known process for generating MPD data to thereby generate the above-described MPD data.

Specifically, the information generation unit 111 describes, in the MPD data, the AdaptationSet element 220 including n SegmentURL elements (240-1, . . . , 240-n) indicating the obtaining reference of the n media segments (250-1, . . . , 250-n) constituting the original video from the viewpoint P (S74)

The information generation unit 111 describes, in the MPD data, the AdaptationSet element 221 including n SegmentURL elements (241-1, . . . , 241-n) indicating the obtaining reference of then media segments (251-1, . . . , 251-n) constituting the original video from the viewpoint Q (S75)

Further, the information generation unit 111 describes, in the MPD data, the AdaptationSet element 222 including one or more SegmentURL elements 242 indicating the obtaining reference(s) of the one or more media segments 252 in which the decimation videos from the viewpoint P and the viewpoint Q are stored (S76).

As a result, the video from the intermediate viewpoint between the viewpoint P and the viewpoint Q is reproduced at high speed, and the above-described MPD data 200 for reproducing the captured videos from the viewpoint P and the viewpoint Q at standard speed is recorded in the storage unit 12.

### 4. Flow of Process in Reproduction Apparatus 20

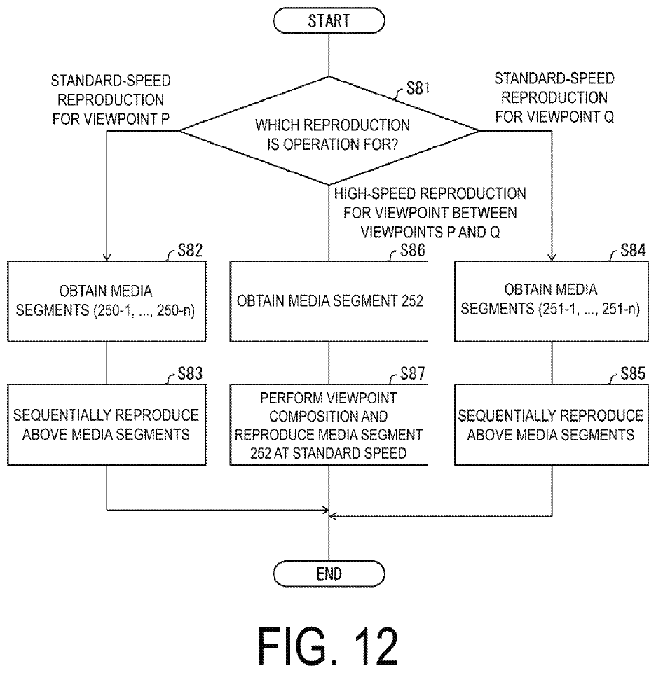

Operations of the reproduction apparatus 20 in a case of receiving an operation for reproducing the captured video from the certain viewpoint P with respect to the above-described MPD data 200 will be described with reference to FIG. 12. FIG. 12 is a flowchart illustrating the above-described operations of the reproduction apparatus.

First, the reproduction processing unit 211 determines the type of a received reproduction operation (S81).

In a case of determining that an operation for performing standard reproduction on the video from the viewpoint P (a second operation) is received, the reproduction processing unit 211 refers to the AdaptationSet element 220 in the MPD data 100 recorded in the storage unit 22.

Specifically, the reproduction processing unit 211 obtains n media segments (250-1, . . . , 250-n) via the receiver 29 with reference to the n SegmentURL elements (240-1, . . . , 240-n) (S82).

The reproduction processing unit 211 reproduces, at standard speed, the obtained n media segments (250-1, . . . , 250-n) in the order of the media segment 250-1, . . . , the media segment 250-n (S83).

In a case of determining that an operation for performing standard reproduction on the video from the viewpoint Q (a second operation) is received, the reproduction processing unit 211 refers to the AdaptationSet element 221 in the MPD data 100 recorded in the storage unit 22.

Specifically, the reproduction processing unit 211 obtains n media segments (251-1, . . . , 251-n) via the receiver 29 with reference to the n SegmentURL elements (241-1, . . . , 241-n) (S84).

The reproduction processing unit 211 reproduces, at standard speed, the obtained n media segments (250-1, . . . , 250-n) in the order of the media segment 250-1, . . . , the media segment 250-n (S85).

In a case of determining that an operation for performing high-speed reproduction on the video from the intermediate viewpoint between the viewpoint P and the viewpoint Q (a first operation) is received, on the other hand, the reproduction processing unit 211 obtains the media segment 252 with reference to the AdaptationSet element 222 (the SegmentURL element 242) in the MPD data 200 recorded in the storage unit 22 (S86).

Next, the reproduction processing unit 211 performs viewpoint composition on the decimation video from the viewpoint P and the decimation video from the viewpoint Q included in the media segment 252. The reproduction processing unit 211 reproduces the decimation video from the intermediate viewpoint thus generated, at standard speed. These operations (S87) are described in more detail as follows.

Specifically, the reproduction processing unit 211 uses a depth map (depth information) obtained based on pairs of I frames (an I frame included in the decimation video from the viewpoint P and an I frame included in the decimation video from the viewpoint Q), the I frames of each pair being generated (captured) at the same time point, in an existing method such as stereo matching, to compose a video from the intermediate viewpoint between the viewpoint P and the viewpoint Q. As a result, the reproduction processing unit 211 obtains a frame group (image group) constituting the decimation video from an intermediate viewpoint between the viewpoint P and the viewpoint Q. The reproduction processing unit 211 sequentially reproduces composed frames (the frames constituting the decimation video) so that the frame (image) composed from the pair of I-frames generated (captured) earlier is reproduced earlier.

Although omitted in the flowchart in FIG. 12, in a case of determining that the operation for performing standard-speed reproduction on the video from the intermediate viewpoint between the viewpoint P and the viewpoint Q (the second operation) is received, the reproduction processing unit 211 refers to the AdaptationSet element 220 and the AdaptationSet element 221 in the MPD data 200 recorded in the storage unit 22.

Specifically, the reproduction processing unit 211 obtains n media segments (250-1, . . . , 250-n) via the receiver 29 with reference to the n SegmentURL elements (240-1, . . . , 240-n) and obtains n media segments (251-1, . . . , 251-n) via the receiver 29 with reference to the n SegmentURL elements (241-1, . . . , 241-n).

The reproduction processing unit 211 performs viewpoint composition and reproduction, based on the obtained n media segments (250-1, . . . , 250-n) and the obtained n media segments (251-1, . . . , 251-n).

Even with the configuration of the present embodiment, it is possible to exert similar effects as those of Embodiment 1 and to also exert other effects that a video from a viewpoint (a viewpoint adjacent to the viewpoint P and the viewpoint Q) that is none of viewpoints (the viewpoint P and the viewpoint Q) of in capturing can be reproduced at high speed with less CPU load.

### Modification

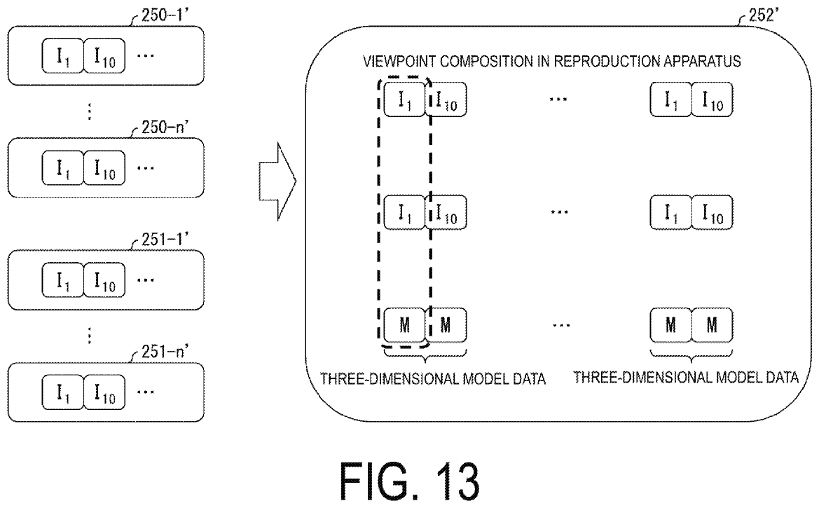

A modification of the present embodiment will be described with reference to FIG. 13. FIG. 13 is a diagram illustrating an example of a media segment related to high-speed reproduction of a video from an intermediate viewpoint between the viewpoint P and the viewpoint Q. In the present modification, three-dimensional model data is further used for a viewpoint composition process to perform viewpoint composition with higher precision. Specifically, with respect to an image of an imaging object included in a multi-viewpoint video, the generation apparatus 10 generates a media segment for high-speed reproduction in such a way as to include the three-dimensional model data indicating the image, and transmits the media segment to the reproduction apparatus 20.

An example of a storage location for the three-dimensional model data is track 3 of a media segment 252′ as illustrated in FIG. 13, for example. Another example may be an aspect in which an initialization segment is used as a region for storing the three-dimensional model data.

According to the above-described configuration, it is not necessary to prepare three-dimensional model data in the reproduction apparatus 20 prior to the reproduction operation. Further, any operation separate from the reproduction operation for preparing a three-dimensional model data in the reproduction apparatus 20 is not necessary either. Hence, with the configuration according to the present modification, it is possible to save resources of the reproduction apparatus 20 while reproducing a video that renders the appearance of an imaging object from an intermediate viewpoint more accurately, and to reduce the time and effort of the user of the reproduction apparatus 20.

Note that the present modification is also applicable to the embodiments to be described later.

### Embodiment 3

Another embodiment of the present invention will be described as follows with reference to FIGS. 1, 9, 11, and 12.

In the present embodiment, a case of reproducing, at high speed, a video with a viewpoint moving between the certain viewpoint P and the certain viewpoint Q in a multi-viewpoint video system will be described.

### 1. Configurations of Generation Apparatus 10 and Reproduction Apparatus 20

The configurations in FIG. 1 are used in the present embodiment similarly to the case of Embodiment 1.

### 2. Regarding MPD Data and Media Segments

The configurations illustrated in FIG. 9 are used in the present embodiment similarly to the case of Embodiment 2.

### 3. Flow of Process in Generation Apparatus 10

The process illustrated in the flowchart of FIG. 11 is performed in the present embodiment similarly to the case of Embodiment 2.

### 4. Flow of Process in Reproduction Apparatus 20

Operations of the reproduction apparatus 20 in a case of receiving an operation for reproducing a video from an arbitrary viewpoint in a case of a viewpoint moving between the certain viewpoint P and viewpoint Q, with reference to the above-described MPD data 200 will be described below with reference to FIG. 12. FIG. 12 is a flowchart illustrating the above-described operations of the reproduction apparatus.

Operations up to step S86 are similar to those in Embodiment 2.

In subsequent step S87, the present embodiment is different from the case of Embodiment 2 in that a video from an intermediate viewpoint (the viewpoint does not change with time) between the viewpoint P and the viewpoint Q is composed in Embodiment 2, but a video from an arbitrary viewpoint (the viewpoint changes with time) between the viewpoint P and the viewpoint Q is composed in the present embodiment.

The reproduction processing unit 211 uses a depth map (depth information) obtained based on pairs of I frames (an I frame included in the decimation video from the viewpoint P and an I frame included in the decimation video from the viewpoint Q), the I frames of each pair being generated (captured) at the same time point, in an existing method such as stereo matching, to compose a video from an arbitrary viewpoint between the viewpoint P and the viewpoint Q.

Note that the moving speed in the case that the viewpoint moves from the viewpoint P to the viewpoint Q is not limited to being uniform. A configuration may be employed in which, even though the times required for move of the viewpoint are the same, a video from a viewpoint close to the viewpoint P is reproduced for a longer time than that for a video from a viewpoint close to the viewpoint Q, for example.

As a result, the reproduction processing unit 211 obtains a frame group (image group) constituting a decimation video. The reproduction processing unit 211 sequentially reproduces the composed frames (the frames constituting the decimation video) so that the frame (image) composed from the pair of I-frames generated (captured) earlier is reproduced earlier. The above reproduction allows a user to watch a video of an imaging object as if the user views a state of the imaging object while actually moving from a point at which the viewpoint P is located to a point at which the viewpoint Q is located. Hence, it appears as if the viewpoint moves from the viewpoint P to the viewpoint Q smoothly as in an animation.

Even with the configuration of the present embodiment, it is possible to exert similar effects to those of Embodiment 2. Further, with the configuration of the present embodiment, it is possible to allow the user to observe a state of the imaging object that can be checked while moving the viewpoint from the point at which the viewpoint P is located to the point at which the viewpoint Q is located, in a shorter period, in the method of high-speed reproduction according to the present embodiment for reducing the load on the CPU in the reproduction apparatus.

### Supplementary Notes According to Embodiments 1 to 3

In a case of generating a decimation video for high-speed reproduction, the generation apparatus 10 may include, in each of various data constituting the decimation video, information indicating that the data is data for high-speed reproduction.

An example of the various data is a media segment. In this example, the generation apparatus 10 may include the information in a styp box of each media segment.

Other examples of the various data include an Initialization Segment and a Self-initializing media segment. In these examples, the generation apparatus 10 may include the information in a compatible_brands field in a ftyp box of each segment.

### Supplementary Notes According to Embodiments 2 and 3

Embodiments 2 and 3 are embodiments according to a multi-viewpoint video system for reproducing a multi-viewpoint video generated by composing captured videos from multiple respective viewpoints circularly surrounding an imaging object.

The technical matters disclosed in Embodiments 2 and 3 are applicable to a multi-viewpoint video system for which captured videos from multiple respective viewpoints spherically surrounding an imaging object are composed.

In this case, the generation apparatus generates MPD data and a media segment group for high-speed reproduction of a video from a certain viewpoint surrounded by four adjacent viewpoints, for example.

Note that the data in each media segment may be formed by storing a frame group for high-speed reproduction deriving from the four viewpoints described above, in one to four tracks of the media segment.

In this case, the reproduction apparatus obtains the above media segment group with reference to the SegmentURL group included in the AdaptationSet that is described in the MPD data and is to be used for high-speed reproduction described above. The reproduction apparatus performs the above high-speed reproduction by using the frame group deriving from the four viewpoints stored in the four tracks of each obtained media segment.

### Other Supplementary Notes

The present invention is not limited to Embodiments 1 to 3 described above and the variations of the embodiments.

Specifically, although Embodiments 1 to 3 described above are embodiments related to reproduction of a partial video in a multi-viewpoint video, an embodiment related to reproduction of a partial video in an entire video (for example, a full spherical video) including partial videos from multiple respective line-of-sight directions is also included within the scope of the present invention.

In other words, embodiments for generating MPD data for reproducing a partial video in a full spherical video, generating a decimation video from an original video, and reproducing a partial video (an original video or a decimation video) by employing any of the methods described in Embodiments 1 to 3 are also included within the scope of the present invention.

### Implementation Examples by Software

The control blocks (especially the controller 11 and the storage unit 12) of the generation apparatus 10 and the control blocks (especially the controller 21 and the storage unit 22) of the reproduction apparatus 20 may be implemented with a logic circuit (hardware) formed as an integrated circuit (IC chip) or the like, or with software.

In the latter case, the generation apparatus 10 includes a computer that executes instructions of a program that is software implementing each function. This computer includes at least one processor (control device) and includes at least one computer-readable recording medium having the program stored thereon, for example. The processor reads from the recording medium and performs the program in the computer to achieve the object of the present invention. For example, a Central Processing Unit (CPU) can be used as the processor. As the above-described recording medium, a “non-transitory tangible medium” such as a tape, a disk, a card, a semiconductor memory, and a programmable logic circuit in addition to a Read Only Memory (ROM) or the like can be used. A Random Access Memory (RAM) or the like for deploying the above program may be further included. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

The generation apparatus 10 according to Aspect 1 of the present invention includes: an information generation unit 111 configured to generate meta-information related to reproduction of a certain partial video in an entire video including partial videos from multiple viewpoints or line-of-sight directions; and a data generation unit 112 configured to generate data indicating a decimation video produced by decimating one or some frames from the certain partial video, wherein the meta-information includes first information indicating an obtaining reference of the decimation video to be referred to in response to a first operation for reproducing the certain partial video at a high speed, and second information indicating an obtaining reference of the certain partial video to be referred to in response to a second operation for reproducing the certain partial video at a lower speed than the high speed for the first operation.

According to the above-described configuration, it is possible to provide the generation apparatus 10 that enables high-speed reproduction of a video to reduce the load on a network and a client.

The generation apparatus 10 according to Aspect 2 of the present invention may be configured such that, in Aspect 1 described above, the entire video is a multi-viewpoint video produced by composing captured videos captured from the multiple viewpoints, and the certain partial video is a captured video of the captured videos captured from a certain viewpoint among the multiple viewpoints.

The generation apparatus 10 according to Aspect 3 may be configured such that, in Aspect 1 described above, the entire video is a multi-viewpoint video produced by composing captured videos captured from the multiple viewpoints, the certain partial video is a partial video from a particular viewpoint, the partial video being obtained by composing a first captured video and a second captured video captured from two viewpoints adjacent to the particular viewpoint, and the data generation unit generates data indicating the decimation video so as to include video data obtained by decimating one or some first frames from the first captured video and video data obtained by decimating, from the second captured video, one or some second frames each of which is generated at a same time point as the one or some first frames.

According to the above-described configuration, it is possible to exert similar effects to those of Aspect 1 and also to exert other effects of reproducing, at high speed, a video from a viewpoint that is not a viewpoint at the time of capturing, with a smaller amount of CPU load.

The generation apparatus 10 according to Aspect 4 may be configured such that, in Aspect 3 described above, the data generation unit 112 generates data indicating the decimation video so as to further include, for an image of an imaging object included in the partial video from the particular viewpoint, three-dimensional model data of the imaging object.

According to the above-described configuration, it is possible to save resources of the reproduction apparatus 20 for viewpoint composition while reproducing a video that renders the appearance of an imaging object from an intermediate viewpoint more accurately.

The generation apparatus 10 according to Aspect 5 may be configured such that, in any of Aspects 1 to 4 described above, at least a Bi-Predictive (B) frame is included in the one or some frames.

According to the above-described configuration, by decimating at least B frames, the reproduction apparatus 20 side does not reproduce the B frames not being able to be reproduced until bi-directional reference images are decoded, at the time of high-speed reproduction of a partial video, so even the reproduction apparatus with low decoding capability exerts the effects of being able to reproduce the partial video at high speed.

The generation apparatus 10 according to Aspect 6 of the present invention may be configured such that, in any one aspect of Aspects 1 to 5 described above, the metadata is Dynamic Adaptive Streaming over HTTP (DASH)-specified MPD data, the data indicating the decimation video includes one or more DASH-specified media segments, the first information includes one or more DASH-specified SegmentURL elements included in a DASH-specified AdaptationSet element, and the AdaptationSet element includes a descriptor indicating that the AdaptationSet element is information indicating the obtaining reference of the decimation video.

According to the above-described configuration, it is possible to exert similar effects to those of Aspect 1 and also to exert effects of checking, in a simple manner, that the AdaptationSet is information indicating the obtaining reference of the decimation video.

The reproduction apparatus 20 according to Aspect 7 of the present invention includes: a reproduction processing unit 211 configured to reproduce, with reference to meta-information related to reproduction of a certain partial video in an entire video including partial videos from multiple viewpoints or line-of-sight directions, the certain partial video or a decimation video produced by decimating one or some frames from the certain partial video, wherein the meta-information includes first information indicating an obtaining reference of the decimation video and second information indicating an obtaining reference of the certain partial video, and the reproduction processing unit 211 reproduces the decimation video obtained based on the first information, in response to a first operation for reproducing the certain partial video at a high speed, and reproduces the certain partial video obtained based on the second information, in response to a second operation for reproducing the certain partial video at a lower speed than the high speed for the first operation.

It is possible to provide the reproduction apparatus 20 that enables high-speed reproduction of a video to reduce the load on a network and a client.

The reproduction apparatus 20 according to Aspect 8 of the present invention may be configured such that, in Aspect 7 described above, the entire video is a multi-viewpoint video produced by composing captured videos captured from the multiple viewpoints, and the certain partial video is a captured video of the captured videos captured from a certain viewpoint among the multiple viewpoints.

According to the above-described configuration, it is possible to exert similar effects to those of Aspect 7.

The reproduction apparatus 20 according to Aspect 9 of the present invention may be configured such that, in Aspect 7 described above, the entire video is a multi-viewpoint video produced by composing captured videos captured from the multiple viewpoints, the certain partial video is a partial video from a particular viewpoint, the partial video being obtained by composing a first captured video and a second captured video captured from two viewpoints adjacent to the particular viewpoint, the reproduction processing unit 211 obtains, with reference to first information, data indicating the decimation video and including video data obtained by decimating one or some first frames from the first captured video and video data obtained by decimating, from the second captured video, one or some second frames each of which is generated at a same time point as the one or some first frames, and the reproduction processing unit 211 sequentially reproduces images from the particular viewpoint, each of the images being obtained by composing a first frame included in one of the video data and a second frame included in a different one of the video data and generated at a same time point as the first frame.

According to the above-described configuration, it is possible to exert similar effects to those of Aspect 7 and also to exert other effects of reproducing, at high speed, a video from a viewpoint that is not a viewpoint at the time of capturing, with a smaller amount of CPU load.

The reproduction apparatus 20 according to Aspect 10 of the present invention may be configured such that, in any one of Aspects 7 to 9 described above, at least a Bi-Predictive (B) frame is included in the one or some frames.

According to the above-described configuration, by decimating at least B frames, the reproduction apparatus 20 side does not reproduce the B frames not being able to be reproduced until bi-directional reference images are decoded, at the time of high-speed reproduction of a partial video, so even the reproduction apparatus with low decoding capability exerts the effects of being able to reproduce the partial video at high speed.

The reproduction apparatus 20 according to Aspect 11 of the present invention may be configured such that, in any one of Aspects 7 to 10 described above, the metadata is Dynamic Adaptive Streaming over HTTP (DASH)-specified MPD data, the data indicating the decimation video includes one or more DASH-specified media segments, the first information includes one or more DASH-specified SegmentURL elements included in a DASH-specified AdaptationSet element, and the AdaptationSet element includes a descriptor indicating that the AdaptationSet element is information indicating the obtaining reference of the decimation video.

According to the above-described configuration, the reproduction apparatus 20 according to Aspect 11 can immediately identify AdaptationSet indicating the obtaining reference of a decimation video to be obtained and reproduced in a case of receiving the first operation. Accordingly, the reproduction apparatus 20 according to Aspect 11 has the advantage that the time lag from receipt of the first operation to start of reproduction of the decimation video is short.

A control program according to Aspect 12 of the present invention is a control program for causing a computer to operate as the generation apparatus 10 according to Aspect 1 described above and may be configured to cause the computer to operate as the generation apparatus 10.

A control program according to Aspect 13 of the present invention may be a control program for causing a computer to operate as the reproduction apparatus 20 according to Aspect 7 described above and may be configured to causing the computer to operate as the reproduction apparatus 20.

A generation method according to Aspect 14 of the present invention is a generation method performed by an apparatus, the generation method including: an information generation step of generating meta-information related to reproduction of a certain partial video in an entire video including partial videos from multiple viewpoints or line-of-sight directions; and a data generation step of generating data indicating a decimation video produced by decimating one or some frames from the certain partial video, wherein the meta-information includes first information indicating an obtaining reference of the decimation video to be referred to in response to a first operation for reproducing the certain partial video at a high speed, and second information indicating an obtaining reference of the certain partial video to be referred to in response to a second operation for reproducing the certain partial video at a lower speed than the high speed for the first operation.

According to the above-described method, it is possible to exert similar effects to those of the generation apparatus according to Aspect 1.

A reproduction method according to Aspect 15 of the present invention is a reproduction method performed by an apparatus, the reproduction method including: a reproduction step of reproducing, with reference to meta-information related to reproduction of a certain partial video in an entire video including partial videos from multiple viewpoints or line-of-sight directions, the certain partial video or a decimation video produced by decimating one or some frames from the certain partial video, the meta-information including first information indicating an obtaining reference of the decimation video and second information indicating an obtaining reference of the certain partial video; and a first obtaining step of obtaining the decimation video, based on the first information, in response to a first operation for reproducing the certain partial video at a high speed; and a second obtaining step of obtaining the certain partial video, based on the second information, in response to a second operation for reproducing the certain partial video at a lower speed than the high speed for the first operation.

According to the above-described method, it is possible to exert similar effects to those of the reproduction apparatus according to Aspect 7.

A recording medium according to Aspect 16 of the present invention may be a computer-readable recording medium having recorded thereon the control program according to Aspect 12. Similarly, the recording medium according to Aspect 17 of the present invention may be a computer-readable recording medium having recorded thereon the control program according to Aspect 13.

The present invention is not limited to each of the above-described embodiments. It is possible to make various modifications within the scope of the claims. An embodiment obtained by appropriately combining technical elements each disclosed in different embodiments falls also within the technical scope of the present invention. Further, combining technical elements disclosed in the respective embodiments makes it possible to form a new technical feature.

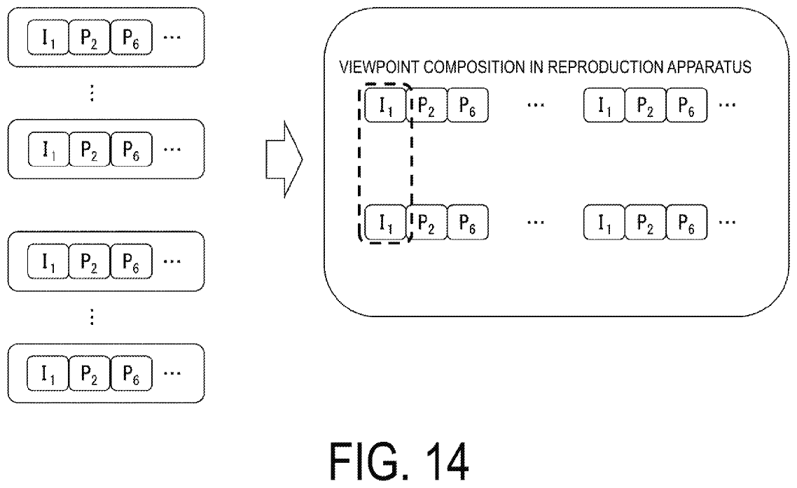

For example, a combination of the technical means disclosed in Modification 1 of Embodiment 1 and the technical means disclosed in Embodiment 2 is conceivable. FIG. 14 is a diagram related to a process for generating a decimation video in an embodiment according to such a combination.

As illustrated in FIG. 14, a system according to the present embodiment can generate and reproduce a decimation video from a viewpoint adjacent to the viewpoint P and the viewpoint Q by decimating only B frames from a captured video from the viewpoint P and decimating only B frames from a captured video from the viewpoint Q. Note that the system may reproduce the frames of the decimation video without decimating any frames but may be configured to reproduce only I frames in the decimation video (in other words, decimate P frames at the time of reproduction).

### CROSS-REFERENCE OF RELATED APPLICATION

The present application relates to the application of JP 2017-152321, filed on Aug. 7, 2017 and claims priority based on the above application. The contents of the above application are included herein by reference.

### REFERENCE SIGNS LIST

10 Generation apparatus
11 Controller (control device)
12 Storage unit
20 Reproduction apparatus
21 Controller
22 Storage unit
23 Display unit

1. A generation apparatus comprising
a memory and
a processor, wherein the processor is configured to perform steps of:
generating meta-information related to reproduction of a certain partial video in an entire video including partial videos from multiple viewpoints or line-of-sight directions; and
generating data indicating a decimation video produced by decimating one or some frames from the certain partial video, wherein
the meta-information includes first information indicating an obtaining reference of the decimation video to be referred to in response to a first operation for reproducing the certain partial video at a high speed, and second information indicating an obtaining reference of the certain partial video to be referred to in response to a second operation for reproducing the certain partial video at a lower speed than the high speed for the first operation.

2. The generation apparatus according to claim 1, wherein
the entire video is a multi-viewpoint video produced by composing captured videos captured from the multiple viewpoints, and
the certain partial video is a captured video of the captured videos captured from a certain viewpoint among the multiple viewpoints.

3. The generation apparatus according to claim 1, wherein
the entire video is a multi-viewpoint video produced by composing captured videos captured from the multiple viewpoints,
the certain partial video is a partial video from a particular viewpoint, the partial video being obtained by composing a first captured video and a second captured video captured from two viewpoints adjacent to the particular viewpoint, and
the processor generates data indicating the decimation video so as to include video data obtained by decimating one or some first frames from the first captured video and video data obtained by decimating, from the second captured video, one or some second frames each of which is generated at a same time point as the one or some first frames.

4. The generation apparatus according to claim 3, wherein the processor generates data indicating the decimation video so as to further include, for an image of an imaging object included in the partial video from the particular viewpoint, three-dimensional model data of the imaging object.

5. The generation apparatus according to claim 1, therein at least a Bi-Predictive (B) frame is included in the one or some frames.

6. The generation apparatus according to claim 1, wherein
the meta-information is Dynamic Adaptive Streaming over HTTP (DASH)-specified MPD data,
the data indicating the decimation video includes one or more DASH-specified media segments,
the first information includes one or more DASH-specified SegmentURL, elements included in a DASH-specified AdaptationSet element, and
the AdaptationSet element includes a descriptor indicating that the AdaptationSet element is infix-illation indicating the obtaining reference of the decimation video.

7. A reproduction apparatus comprising:
a memory and
a processor, wherein the processor is configured to perform a step of
reproducing, with reference to meta-information related to reproduction of a certain partial video in an entire video including partial videos from multiple viewpoints or line-of-sight directions, the certain partial video or a decimation video produced by decimating one or some frames from the certain partial video, wherein
the meta-information includes first information indicating an obtaining reference of the decimation video and second information indicating an obtaining reference of the certain partial video, and
the processor reproduces the decimation video obtained based on the first information, in response to a first operation for reproducing the certain partial video at a high speed, and reproduces the certain partial video obtained based on the second information, in response to a second operation for reproducing the certain partial video at a lower speed than the high speed for the first operation.

8. The reproduction apparatus according to claim 7, wherein
the entire video is a multi-viewpoint video produced by composing captured videos captured from the multiple viewpoints, and
the certain partial video is a captured video of the captured videos captured from a certain viewpoint among the multiple viewpoints.

9. The reproduction apparatus according to claim 7, wherein
the entire video is a multi-viewpoint video produced by composing captured videos captured from the multiple viewpoints,
the certain partial video is a partial video from a particular viewpoint, the partial video being obtained by composing a first captured video and a second captured video captured from two viewpoints adjacent to the particular viewpoint,
the processor obtains, with reference to the first information, data indicating the decimation video and including video data obtained by decimating one or some first frames from the first captured video and video data obtained by decimating, from the second captured video, one or some second frames each of which is generated at a same time point as the one or some first frames, and
sequentially reproduces images from the particular viewpoint, each of the images being obtained by composing a first frame included in one of the video data and a second frame included in a different one of the video data and generated at a same time point as the first frame.

10. The reproduction apparatus according to claim 7, wherein at least a Bi-Predictive (B) frame is included in the one or some frames.

11. The reproduction apparatus according to claim 7, wherein
the meta-information is Dynamic Adaptive Streaming over HTTP (DASH)-specified MPD data,
the data indicating the decimation video includes one or more DASH-specified media segments,
the first information includes one or more DASH-specified SegmentURL elements included in a DASH-specified AdaptationSet element, and
the AdaptationSet element includes a descriptor indicating that the AdaptationSet element is information indicating the obtaining reference of the decimation video.

12.-13. (canceled)

14. A generation method performed by an apparatus, the generation method comprising:
generating meta-information related to reproduction of a certain partial video in an entire video including partial videos from a multiple viewpoints or line-of-sight directions; and
generating data indicating a decimation video produced by decimating one or some frames from the certain partial video, wherein
the meta-information includes first information indicating an obtaining reference of the decimation video to be referred to in response to a first operation for reproducing the certain partial video at a high speed, and second information indicating an obtaining reference of the certain partial video to be referred to in response to a second operation for reproducing the certain partial video at a lower speed than the high speed for the first operation.

15.-17. (canceled)
